(19) United States
(12) Patent Application Publication
(10) Pub. No.: US 2024/0369726 A1
(43) Pub. Date: Nov. 7, 2024

(54) ACTIVE SEISMIC SOURCE GENERATION FOR DISTRIBUTED ACOUSTIC SENSING, GEO-TAGGING, AND SUBSURFACE IMAGING

(71) Applicant: X Development LLC, Mountain View, CA (US)

(72) Inventors: Alex S. Miller, Cambridge, MA (US); Robert Clapp, Sunnyvale, CA (US); Artem Goncharuk, Mountain View, CA (US); Kevin Forsythe Smith, Pleasanton, CA (US); Joseph Hollis Sargent, San Francisco, CA (US); Shane Washburn, Oakland, CA (US); Jonathan Gray Wilfong, San Carlos, CA (US); Allen Richard Zhao, Mountain View, CA (US); Jonathan Blair Ajo-Franklin, Houston, TX (US)

(21) Appl. No.: 18/654,765

(22) Filed: May 3, 2024

Related U.S. Application Data
(60) Provisional application No. 63/499,760, filed on May 3, 2023.

(51) Int. Cl. G01V 1/22; G01V 1/04; G01V 1/143; G01V 1/34

(52) U.S. Cl. CPC G01V 1/226; G01V 1/04; G01V 1/143; G01V 1/345

(57) ABSTRACT

A system includes a mobile vehicle including a geolocator and an active acoustic source configured to generate acoustic wave energy directed toward a fiber optic network that includes one or more fiber optic cables and a distributed acoustic sensing (DAS) interrogator communicably coupled to the one or more fiber optic cables; and a control system. The control system is configured to perform operations including acquiring a signal from the DAS interrogator in response to the acoustic wave energy generated from the active acoustic energy source during movement of the mobile vehicle on or above the terranean surface; determining a geolocation of the mobile vehicle from the geolocator during or subsequent to acquisition of the signal from the DAS interrogator; and determining a location of the at least one fiber optic cable based on the determined geolocation of the mobile vehicle during acquisition of the signal from the DAS interrogator.

### CROSS-REFERENCE TO RELATED APPLICATION

This application claims priority under 35 U.S.C. § 119 to U.S. Provisional Patent Application Ser. No. 63/499,760, filed on May 3, 2023, the entire contents of which are incorporated by reference herein.

### TECHNICAL FIELD

This disclosure generally relates to monitoring the subsurface.

### BACKGROUND

Monitoring the subsurface can be achieved in seismic imaging where a variety of sound generators are used. Examples include thumper trucks, explosives, and air guns. Deployment of such sound generators can be costly and time-consuming. In particular, these examples of sound generators can be loud and physically disruptive, thereby rendering these examples unsuitable in an inhabited environment, for example, an urban environment.

### SUMMARY

The present disclosure describes a technology that leverages mobile platforms, such as vehicles or low-flying UAVs, to mount active acoustic sources that generate vibrational energy that can be detected by sensors. The acoustic waves propagating in the subsurface can be sensed by a fiber optical cable (or network) buried underground, on the surface, suspended in the air (e.g., utility poles), or attached to built infrastructure (e.g., pipelines, bridges, roads, rail tracks, buildings) and equipped with distributed acoustic sensing (DAS) technologies (e.g., a DAS interrogator unit). By synchronously coordinating the emission of the vibrational energy source and propagation and the sensing of the acoustic waves, implementations of the present disclosure can gain information of the subsurface (e.g., near-surface geologic stratigraphy, velocity profiles, imagery), underneath and near the mobile platforms, monitor the surface and subsurface infrastructure, and the integrity of the fiber-optic network.

In an example implementation, a system includes a mobile vehicle including a geolocator and at least one active acoustic source configured to generate acoustic wave energy directed toward a fiber optic network that includes one or more fiber optic cables and at least one distributed acoustic sensing (DAS) interrogator communicably coupled to at least one of the one or more fiber optic cables; and a control system. The control system is configured to perform operations including acquiring a signal from the at least one DAS interrogator in response to the acoustic wave energy generated from the at least one active acoustic energy source during movement of the mobile vehicle on or above the terranean surface; determining a geolocation of the mobile vehicle from the geolocator during or subsequent to acquisition of the signal from the at least one DAS interrogator; and determining a location of the at least one fiber optic cable based on the determined geolocation of the mobile vehicle during acquisition of the signal from the at least one DAS interrogator.

In an aspect combinable with the example implementation, the operations include determining a characteristic of the acquired signal from the at least one DAS interrogator in response to the acoustic wave energy generated from the at least one active acoustic energy source during movement of the mobile vehicle on or above the terranean surface; and based on the characteristic, determining a defect in the at least one fiber optic cable.

In another aspect combinable with any of the previous aspects, the operations include determining a location of the defect in the at least one fiber optic cable based on the determined geolocation of the mobile vehicle during acquisition of the signal from the at least one DAS interrogator.

In another aspect combinable with any of the previous aspects, the characteristic includes an amplitude or a frequency of the acquired signal from the at least one DAS interrogator.

In another aspect combinable with any of the previous aspects, the acoustic wave energy is operable to penetrate through a terranean surface into a subsurface volume that encloses the fiber optic network.

In another aspect combinable with any of the previous aspects, the operations include generating, at least partially based on the acquired signal from the at least one DAS interrogator, an image of the subsurface volume.

In another aspect combinable with any of the previous aspects, the operation of acquiring the signal from the at least one DAS interrogator in response to the acoustic wave energy generated from the at least one active acoustic energy source during movement of the mobile vehicle on or above the terranean surface includes acquiring a plurality of signals from the at least one DAS interrogator in response to the acoustic wave energy generated from the at least one active acoustic energy source during movement of the mobile vehicle on or above the terranean surface.

In another aspect combinable with any of the previous aspects, the operations include determining a plurality of geolocations of the mobile vehicle from the geolocator during or subsequent to acquisition of the plurality of signals from the at least one DAS interrogator; and associating each geolocation of the plurality of geolocations with a particular signal of the plurality of signals acquired from the at least one DAS interrogator.

In another aspect combinable with any of the previous aspects, the acoustic wave energy is operable to penetrate through a terranean surface into a subsurface volume that encloses the fiber optic network, and the operations include generating, at least partially based on the acquired plurality of signals from the at least one DAS interrogator, a dynamic image of the subsurface volume during movement of the mobile vehicle.

In another aspect combinable with any of the previous aspects, the operations include projecting the dynamic image of the subsurface volume at the mobile vehicle during movement of the mobile vehicle.

In another aspect combinable with any of the previous aspects, the at least one active acoustic source includes a speaker tilted toward a location of the fiber optic network and configured to generate the acoustic wave energy.

In another aspect combinable with any of the previous aspects, the acoustic wave energy is generated between 10 Hz and 20 Hz.

In another aspect combinable with any of the previous aspects, the speaker includes a parabolic surface configured to direct the acoustic wave energy into the subsurface volume.

In another aspect combinable with any of the previous aspects, the acoustic wave energy is between 100 W and 10000 W.

In another aspect combinable with any of the previous aspects, the at least one active acoustic source includes a non-transducer source mounted on the mobile vehicle.

In another aspect combinable with any of the previous aspects, the non-transducer source is configured to strike the terranean surface to generate the acoustic wave energy during movement of the mobile vehicle.

In another aspect combinable with any of the previous aspects, the generated acoustic wave energy is between 10 Hz and 20 Hz.

In another aspect combinable with any of the previous aspects, the non-transducer source includes at least one of: a snow tire, a non-uniform tire, an etched tire, an eccentric wheel, a studded tire, a square tires, a flat tire, a forklift tire, or an offset tire.

In another aspect combinable with any of the previous aspects, the non-transducer source is towed by the mobile vehicle.

In another aspect combinable with any of the previous aspects, the mobile vehicle includes an autonomous mobile vehicle.

In another aspect combinable with any of the previous aspects, the autonomous mobile vehicle includes an autonomous roadway vehicle.

In another aspect combinable with any of the previous aspects, the mobile vehicle is a first mobile vehicle and the system includes a second mobile vehicle that includes a second geolocator and at least one second active acoustic source configured to generate acoustic wave energy directed toward the fiber optic network.

In another aspect combinable with any of the previous aspects, the operations include acquiring a second signal from the at least one DAS interrogator in response to the acoustic wave energy generated from the at least one second active acoustic energy source during movement of the second mobile vehicle on or above the terranean surface; determining a geolocation of the second mobile vehicle from the second geolocator during or subsequent to acquisition of the second signal from the at least one DAS interrogator; and determining a second location of the at least one fiber optic cable based on the determined second geolocation of the second mobile vehicle during acquisition of the second signal from the at least one DAS interrogator.

In another aspect combinable with any of the previous aspects, the first and second mobile vehicles are or are part of a platoon of mobile vehicles.

In another aspect combinable with any of the previous aspects, the platoon of mobile vehicles includes a platoon of autonomous mobile vehicles.

In another aspect combinable with any of the previous aspects, the fiber optic network is mounted on infrastructure above the terranean surface, and the at least one active acoustic source is configured to the generate acoustic wave energy directed toward the fiber optic network.

In another aspect combinable with any of the previous aspects, the infrastructure includes one or more utility poles.

In another example implementation, a method includes generating, from at least one active acoustic source on a mobile vehicle during movement of the mobile vehicle on or above a terranean surface, acoustic wave energy directed toward a fiber optic network including one or more fiber optic cables and at least one distributed acoustic sensing (DAS) interrogator communicably coupled to at least one of the one or more fiber optic cables; acquiring a signal from the at least one DAS interrogator in response to the acoustic wave energy generated from the at least one active acoustic energy source; determining, with a geolocator on the mobile vehicle, a geolocation of the mobile vehicle during or subsequent to acquisition of the signal from the at least one DAS interrogator; and determining a location of the at least one fiber optic cable based on the determined geolocation of the mobile vehicle during acquisition of the signal from the at least one DAS interrogator.

An aspect combinable with the example implementation includes determining a characteristic of the acquired signal from the at least one DAS interrogator in response to the acoustic wave energy generated from the at least one active acoustic energy source during movement of the mobile vehicle on or above the terranean surface; and based on the characteristic, determining a defect in the at least one fiber optic cable.

Another aspect combinable with any of the previous aspects includes determining a location of the defect in the at least one fiber optic cable based on the determined geolocation of the mobile vehicle during acquisition of the signal from the at least one DAS interrogator.

In another aspect combinable with any of the previous aspects, the characteristic includes an amplitude or a frequency of the acquired signal from the at least one DAS interrogator.

In another aspect combinable with any of the previous aspects, the acoustic wave energy is operable to penetrate through a terranean surface into a subsurface volume that encloses the fiber optic network.

Another aspect combinable with any of the previous aspects includes generating, at least partially based on the acquired signal from the at least one DAS interrogator, an image of the subsurface volume.

In another aspect combinable with any of the previous aspects, acquiring the signal from the at least one DAS interrogator in response to the acoustic wave energy generated from the at least one active acoustic energy source includes acquiring a plurality of signals from the at least one DAS interrogator in response to the acoustic wave energy generated from the at least one active acoustic energy source during movement of the mobile vehicle on or above the terranean surface.

Another aspect combinable with any of the previous aspects includes determining a plurality of geolocations of the mobile vehicle from the geolocator during or subsequent to acquisition of the plurality of signals from the at least one DAS interrogator; and associating each geolocation of the plurality of geolocations with a particular signal of the plurality of signals acquired from the at least one DAS interrogator.

In another aspect combinable with any of the previous aspects, the acoustic wave energy is operable to penetrate through a terranean surface into a subsurface volume that encloses the fiber optic network.

Another aspect combinable with any of the previous aspects includes generating, at least partially based on the acquired plurality of signals from the at least one DAS interrogator, a dynamic image of the subsurface volume during movement of the mobile vehicle.

Another aspect combinable with any of the previous aspects includes projecting the dynamic image of the subsurface volume at the mobile vehicle during movement of the mobile vehicle.

In another aspect combinable with any of the previous aspects, the at least one active acoustic source includes a speaker tilted to at least partially face the subsurface volume.

Another aspect combinable with any of the previous aspects includes generating the acoustic wave energy from the speaker during movement of the mobile vehicle on or above the terranean surface.

In another aspect combinable with any of the previous aspects, the acoustic wave energy is generated between 10 Hz and 20 Hz.

Another aspect combinable with any of the previous aspects includes directing the acoustic wave energy into a subsurface volume from a parabolic surface of the speaker.

In another aspect combinable with any of the previous aspects, the acoustic wave energy is between 100 W and 10000 W.

In another aspect combinable with any of the previous aspects, the at least one active acoustic source includes a non-transducer source mounted on the mobile vehicle.

Another aspect combinable with any of the previous aspects includes generating the acoustic wave energy from the non-transducer source during movement of the mobile vehicle on or above the terranean surface.

In another aspect combinable with any of the previous aspects, generating the acoustic wave energy from the non-transducer source during movement of the mobile vehicle on or above the terranean surface includes operating the non-transducer source to strike the terranean surface to generate the acoustic wave energy during movement of the mobile vehicle.

In another aspect combinable with any of the previous aspects, the generated acoustic wave energy is between 10 Hz and 20 Hz.

In another aspect combinable with any of the previous aspects, the non-transducer source includes at least one of: a snow tire, a non-uniform tire, an etched tire, an eccentric wheel, a studded tire, a square tires, a flat tire, a forklift tire, or an offset tire.

In another aspect combinable with any of the previous aspects, the non-transducer source is towed by the mobile vehicle.

In another aspect combinable with any of the previous aspects, the mobile vehicle includes an autonomous mobile vehicle.

In another aspect combinable with any of the previous aspects, the autonomous mobile vehicle includes an autonomous roadway vehicle.

In another aspect combinable with any of the previous aspects, the mobile vehicle is a first mobile vehicle, and the method includes generating, from at least one second active acoustic source on a second mobile vehicle during movement of the second mobile vehicle on or above the terranean surface, second acoustic wave energy directed toward the fiber optic network including one or more fiber optic cables and at least one DAS interrogator communicably coupled to at least one of the one or more fiber optic cables; acquiring a second signal from the at least one DAS interrogator in response to the second acoustic wave energy generated from the at least one second active acoustic energy source; determining, with a geolocator on the second mobile vehicle, a geolocation of the second mobile vehicle during or subsequent to acquisition of the second signal from the at least one DAS interrogator; and determining a second location of the at least one fiber optic cable based on the determined geolocation of the second mobile vehicle during acquisition of the second signal from the at least one DAS interrogator.

In another aspect combinable with any of the previous aspects, the first and second mobile vehicles are or are part of a platoon of mobile vehicles.

In another aspect combinable with any of the previous aspects, the platoon of mobile vehicles includes a platoon of autonomous mobile vehicles.

In another aspect combinable with any of the previous aspects, the fiber optic network is mounted on infrastructure above the terranean surface, the method including directing the generate acoustic wave energy towards the fiber optic network mounted on the infrastructure.

In another aspect combinable with any of the previous aspects, the infrastructure includes one or more utility poles.

The details of one or more implementations of the subject matter of this specification are set forth in the description, the accompanying drawings, and the claims. Other features, aspects, and advantages of the subject matter will become apparent from the description, the claims, and the accompanying drawings.

### DESCRIPTION OF DRAWINGS

### Disclosure

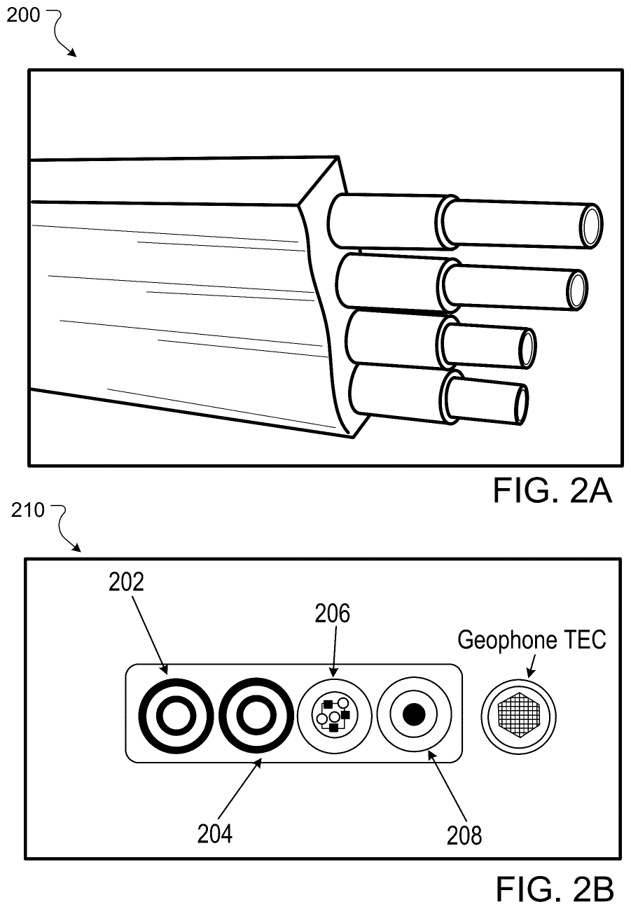

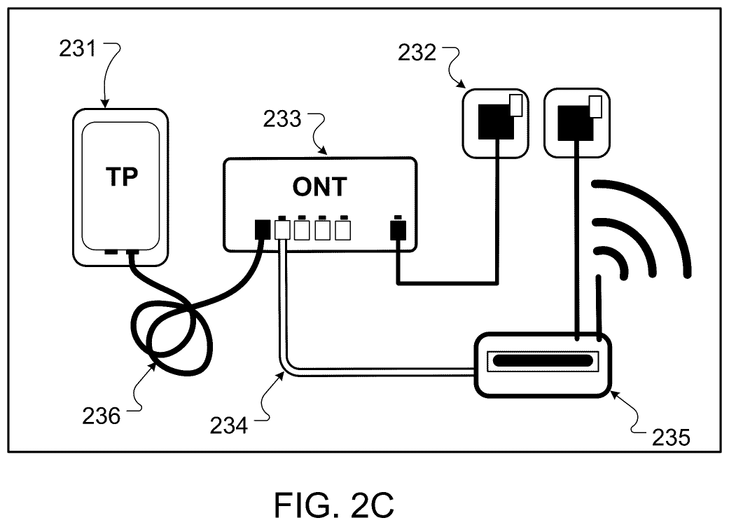

FIGS. 2A-2B show examples of fiber-optic cables with distributed acoustic sensing (DAS) capability according to the present disclosure.

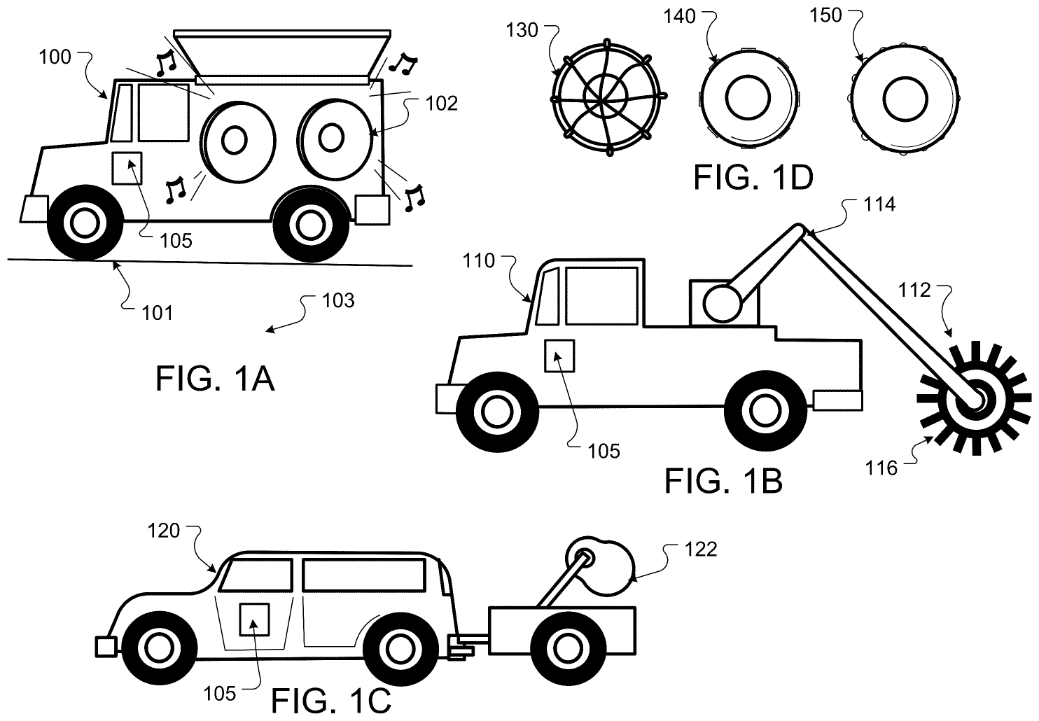

FIGS. 1A-1D show examples of active acoustic sources according to the present

FIG. 2C shows an example of a DAS interrogator to provide DAS capability to an underground fiber-optic network according to the present disclosure.

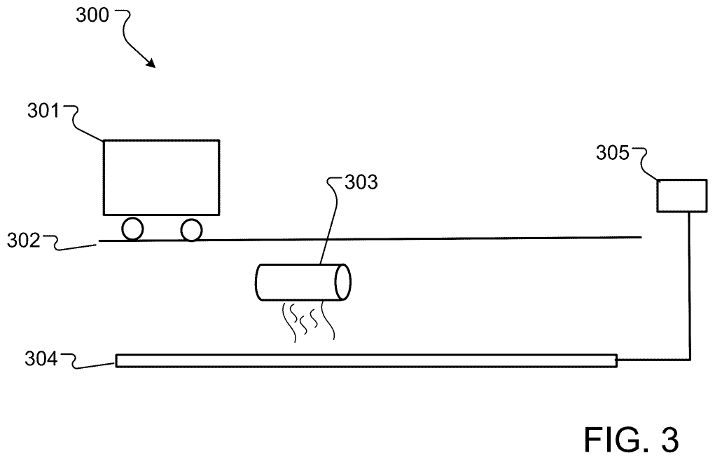

FIG. 3 is a diagram illustrating an example of incorporating active acoustic sources and an underground fiber optical network according to the present disclosure.

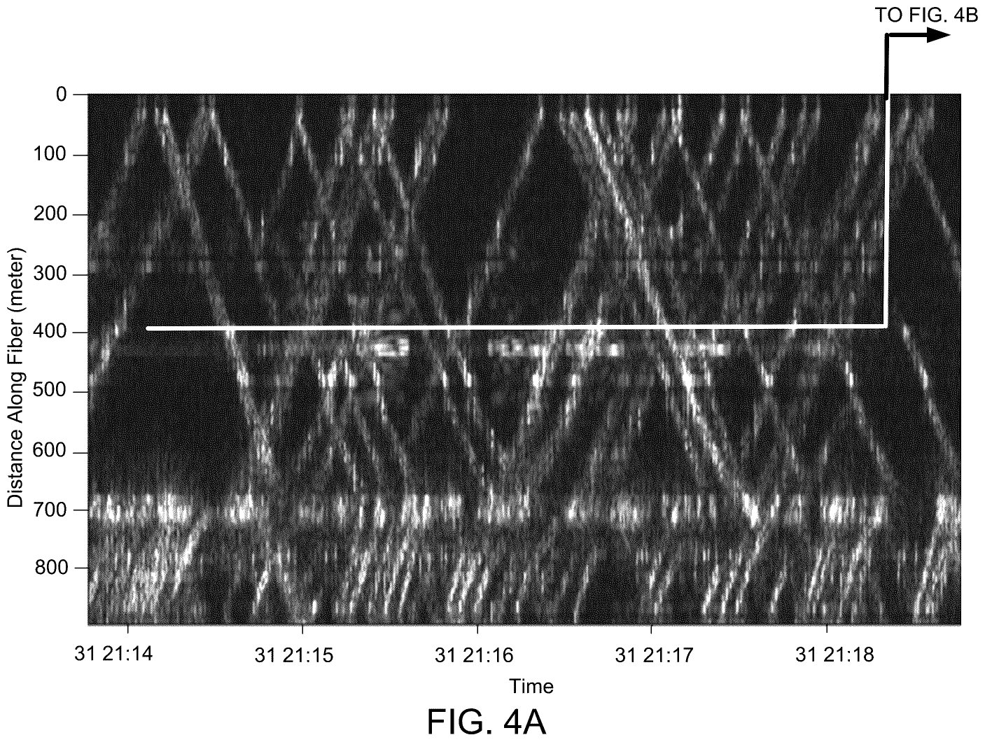

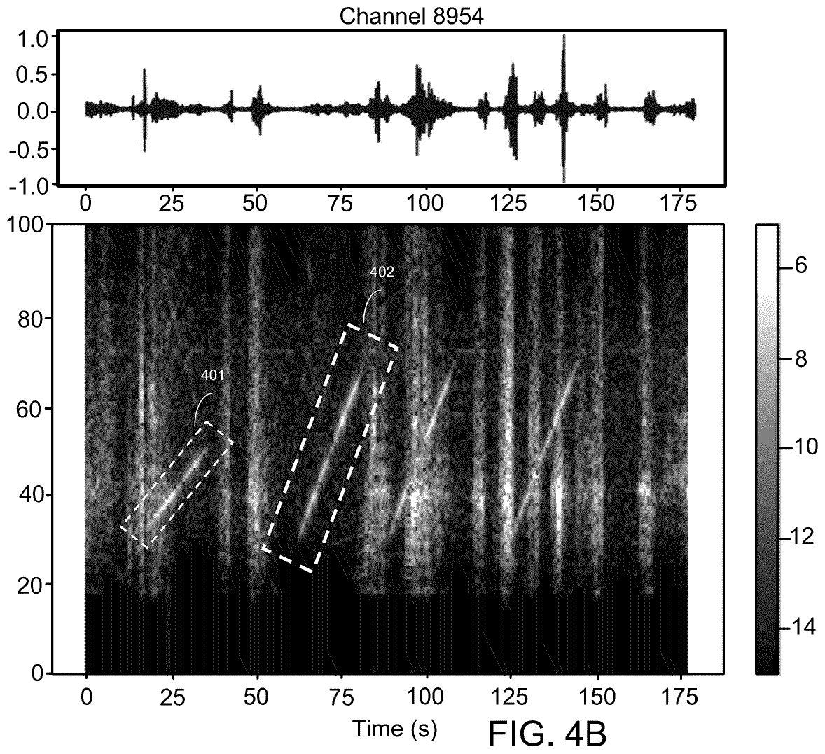

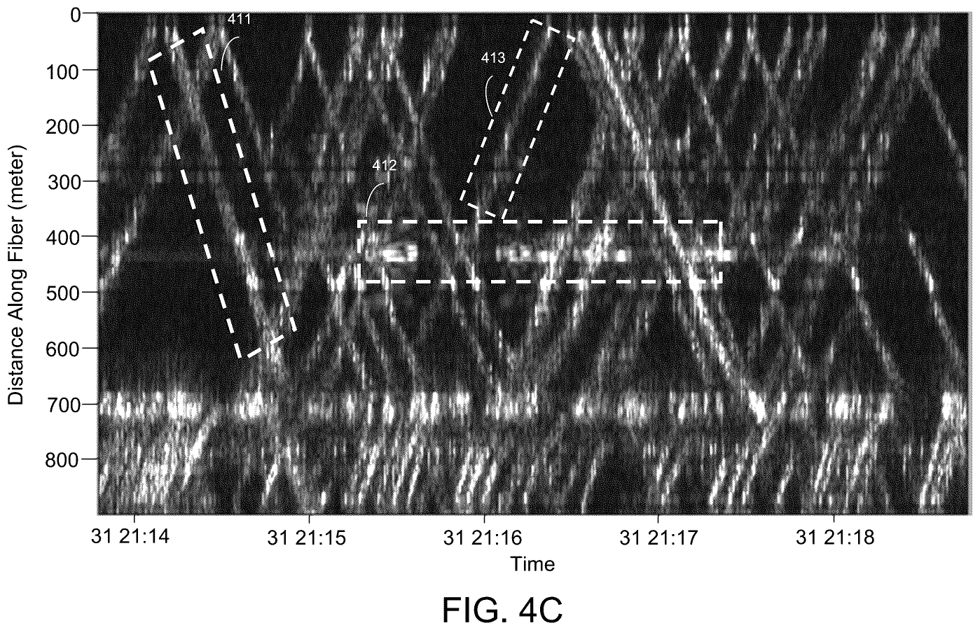

FIGS. 4A-4C shows examples of test data according to the present disclosure.

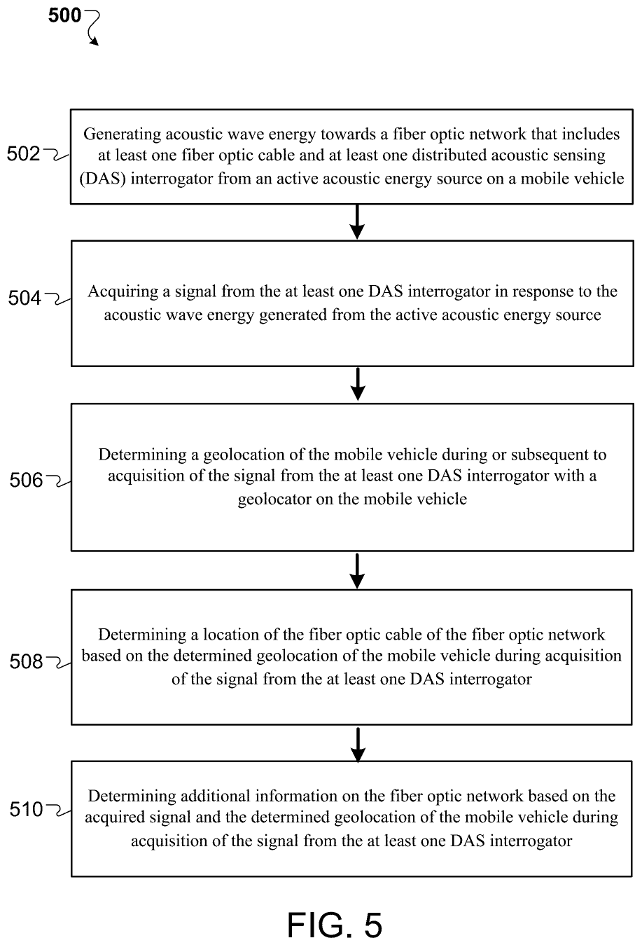

FIG. 5 shows an example method according to the present disclosure.

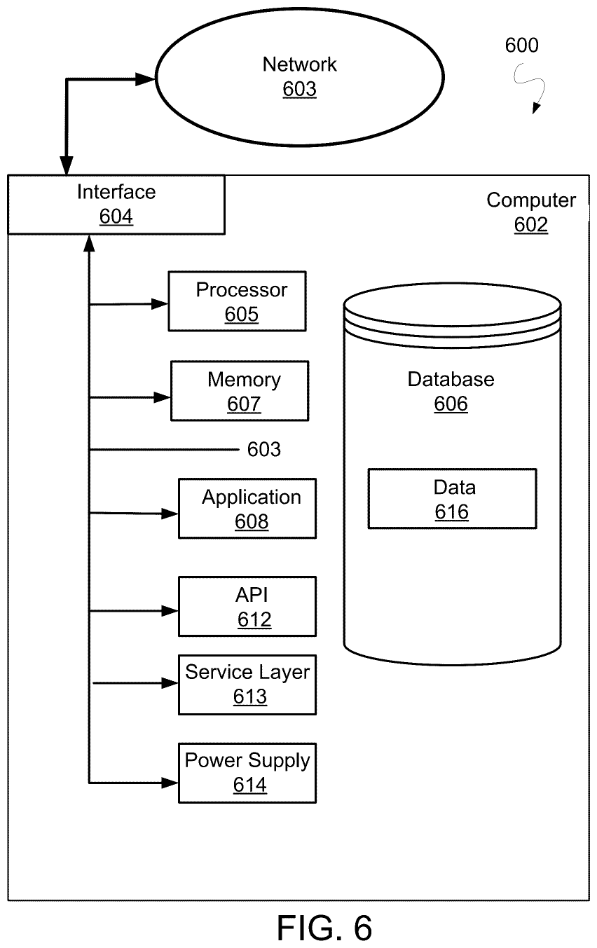

FIG. 6 shows an example of a computer system for implementing a control unit according to the present disclosure.

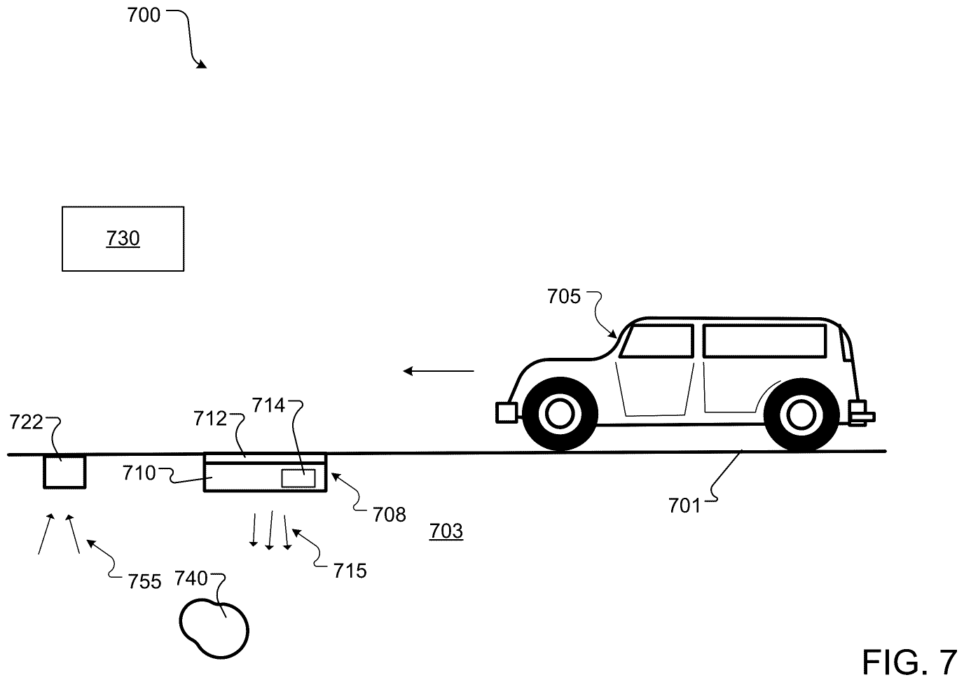

FIG. 7 shows a schematic diagram of an example implementation of a seismic imaging system according to the present disclosure.

### DETAILED DESCRIPTION

During land surveillance, imaging the subsurface and monitoring the underground generally entails directing energy (e.g., acoustic energy in the form of vibrations) into the subsurface, recording signals that correspond to reverberations of the input energy using sensor arrays, and then analyzing the recorded signals to determine how the energy travels through the subsurface medium. While fiber-optic cables with distributed acoustic sensing (DAS) channels can act as a linear sensor array over long distances, there is a dearth of techniques for providing source energy for locating the position of the DAS channels within the fiber-optic cable. Moreover, acoustically acquiring the signal that corresponds to the input energy traveling through and reverberating within the subsurface for imaging purposes can be costly and cumbersome.

Implementations of the present disclosure can incorporate a mobile source that generates directed energy tuned to specific settings (e.g., frequency, amplitude, and pattern of waveforms). The mobile source can include mobile vehicles that carry acoustic sources as a type of “audio speaker” to produce a directed and optimized output of vibrational energy. Examples of vehicle-mounted acoustic sources can include a mechanical off-balance/noise producing apparatus such as an oscillating vibrating mechanism, a non-uniform tire, etched tires, offset tires, and chains/snow tires. These sources, when carried by mobile vehicles, can launch vibrational energy of desired directivity, magnitude, and timing offset to facilitate recognizable signal acquisition (that stands out above the noise) by the DAS channels of the underground fiber-optic network.

Seismic imaging can use a variety of source/signal generators (e.g., thumper trucks, air guns, explosives, hammer) to generate the input energy (i.e., an active source). However, deployment of such bulky signal sources tend to be costly, time-consuming, and physically disruptive. In particular, the equipment can be expensive to acquire or rent, set up, and operate. During operation, the system is often loud and physically disruptive when generating ground vibrations intended for a geo-exploration site that is uninhabited.

Referring to FIGS. 1A to ID, implementations of the present disclosure incorporate active sources that are mobile but have precise location data (e.g., geolocation data) to allow a large DAS network to produce imagery or sensing read-out without the annoyance of sources used by geo-exploration. Moreover, the detection by the DAS fiber network can also be more sensitive than using passive sources alone (e.g., structures that do actively generate vibrational signals, but instead reflecting or scattering vibrational signals launched into the fiber-optic cable) or passive detection using acoustic means (e.g., using hydrophone arrays).

For example, the implementations can incorporate a vehicle to provide a mobile platform. As illustrated, mobile platform 100 can be a vehicle carrying vibrational sources (including, for example, a transducer/speaker based device) on a terranean surface 101 (e.g., a roadway or otherwise) over a subsurface volume 103 that includes a fiber optic network (shown in other figures). In the illustrated configuration, adding a high gain setup (such as with a parabolic dish, or by adding baffles) can increase efficiency of energy coupled to the ground. The illustration particularly shows the vibration sources arranged as speakers 102, which can include sub-woofers and can generate and send vibrational energy (e.g., below audio range) into the ground. Although illustrated as mounted sideward, speakers 102 can be tilted to face downward. Alternatively, the speakers 120 can be, for example, directed toward a fiber optic network located above ground, such as suspended by utility poles or other infrastructure (or in any direction, as needed). Speakers 102 can be equipped with amplifiers to generate an output power exceeding 1000 W (e.g., up to 2000 W) to provide sufficient energy of vibrational waves entering the subsurface for surveying the land, or testing the integrity of the fiber-optic network buried underground.

In some implementations, the acoustic energy can be at higher frequencies that are in the audio range of human perception. But in any event, such acoustic energy can still be at a lower end of human perception so as to not be disruptive in an urban/populated environment.

Mobile platform 100 also includes a geolocator 105, such as a GPS or other location unit. Geolocator 105 operates to provide a precise or substantially accurate (e.g., within 0-3 meters, within 0-5 meters, or otherwise) global location with a timestamp of the mobile platform 100 (as well as mobile platforms 110 and 120, as shown) as the mobile platform 100 is mobile or stationary.

FIG. 1B illustrates another example mobile platform 110, which can be a pickup truck towing non-transducer sources (such as a tire device 112) on hinge 114. By tuning the mass and material characteristics of the teeth structure 116 of tire device 112, along with the driving speed of the mobile platform 110, the low frequency output can be optimized for coupling vibrational energy into the subsurface.

FIG. 1C illustrates another example implementation of a mobile platform 120. In this example, the mobile platform 120 is a vehicle that carries a mechanical off-balance/noise producing apparatus 122. Apparatus 122 can include an oscillating vibrating mechanism that can actuate (e.g., up and down), like a swinging pendulum, to generate vibrational energy for coupling into the sub-surface. In other example implementations, the mobile platform 120 can have speakers 102 mounted in a trailer rather than apparatus 122. The speakers 120 can be, for example, directed toward the terranean surface 101 (in the case of a fiber optic network located in subsurface volume 103) or directed toward a fiber optic network located above ground, such as suspended by utility poles or other infrastructure.

FIG. 1D shows example implementations of tires that can be used on a mobile vehicle to produce vibrational energy during travel of the mobile vehicle (e.g., in addition to or in place of acoustic and/or vibrational energy produced by the speakers 102, tire device 112, and/or apparatus 122). These examples in FIG. 1D include chained tires 130, non-uniform (e.g., eccentric) tires 140, and snow/studded tires 150. Other non-uniform tires, such as etched tires, reaction wheels (e.g., a momentum wheel that provides a torque on the vehicle), square tires, flat tires, forklift tires, and offset tires can also be employed on a mobile vehicle to create vibration energy upon impact (e.g., when tire surface hits the road). In this manner, as the vehicle travels, the vibrational energy can be coupled to the subsurface of the road travelled. To increase coupling with the ground, implementations can provide additional wheels that are deployable and will touch the ground (when, e.g., no passengers are in the vehicle). In some aspects, the implementations can provide a deployable structure (e.g., a movable speed bump) that gives better coupling which activates when the car is stopped. In some aspects, each of mobile platforms 100, 110, and 120, as well as mobile vehicles that employ one or more of the example tires 130, 140, or 150, can be a partially or fully autonomous vehicle.

Referring to FIGS. 2A-2C, examples of a Distributed Acoustic Sensing (DAS) fiber-optic network can enable the sensing of acoustic or seismic waves along the length of a fiber-optic cable. FIGS. 2A-2B respectively show the perspective view 200 and the cross-sectional view 210 of an example of the fiber hardware. As illustrated, the hardware casing can include tubing 202 for hydraulic line, tubing 204 for sampler, tubing 206 for fiber optical cable, and tubing 208 for a monitoring cable. FIG. 2C shows a DAS interrogator unit 232 that connects to an underground optical fiber network.

In a DAS fiber-optic network, a laser source (e.g., located optical terminal 233) can generate a laser light for DAS interrogator 232 so that the laser light is coupled to fiber optical cable 236, and then to termination point (TP) 231 before entering fiber optical cable 236 (which is buried underground). The fiber-optic cable 236 can act as a long and thin series of sensors. When the incident laser light is scattered by disturbance in the fiber, such as those created by acoustic or seismic waves, the resulting changes in the intensity of the light are backscattered and can be used to sense these acoustic or seismic waves.

This basic principle is known as Rayleigh backscattering. Rayleigh backscattering occurs when the light that is launched into the fiber encounters small variations in the refractive index along the length of the fiber, causing some of the light to scatter back towards the source. When an acoustic wave propagates along the fiber, it causes small changes in the refractive index of the fiber, leading to variations in the amount of backscattered light. By analyzing the changes in the backscattered light, which can be detected by photodetectors on DAS interrogator 232 as an electric output signal which can be provided via electrical cable 234 to electrical terminal 235. In a DAS system, when the backscattered light is collected using a photodetector, the electric output signals (e.g., at electrical terminal 235) can be processed using specialized hardware and software to provide information on the time and location of the acoustic waves traveling along the length of the fiber.

FIG. 3 is a diagram 300 illustrating an example of incorporating active acoustic sources and an underground fiber optical network according to some implementations of the present disclosure. Mobile platform 301 can include a vehicle (such as a car, a taxi, a truck, or a van) carrying active acoustic sources capable of emitting vibrational energy into the subsurface 302 (with examples shown in FIGS. 1A-1C). In some cases, the source can be attached to a trailer to be interchangeable across multiple vehicles. The source can also be attached to a fleet of autonomous vehicles or GPS-enabled transportation vehicles like buses. The source can also be attached to an unmanned aerial vehicle (UAV) which can land or approach the ground during use.

In some cases, a single frequency outside the range of most other noise sources (such as a car) can be used to easily identify the specific vehicle carrying the source. In other cases, a varied frequency source, such as a swept-scan, can be used to achieve a form of seismic imaging of the subsurface. The frequency variation can be used for a physically stationary source or with the vehicle moving.

As described above in association with FIGS. 1A-1D, the active acoustic sources can send vibrational energy between 10 Hz and 20 Hz (or other frequencies, within our outside of human perception), and at an output power of 100 W-1000 W. The frequency, magnitude, and phase of the emissions can be controlled and adjusted. For example, some implementations can pursue a continuous wave (CW) mode of operation while others can implement pulsed mode, or a burst mode, or a specified and identifiable pattern. Significantly, the mobile platform 301 can move. For example, when the vehicle travels, the locatable signal can be sensed and analyzed for the purposes of locating fiber-optic cables and surveying underground stratigraphy/characteristics and infrastructure.

Alternatively, or additionally, the integrity of the fiber-optic network (whether underground or above ground, such as on utility poles or other infrastructure) can be monitored. This is because defects in the fiber optical network can be detected when acoustic waves impinge on the defective section of the fiber-optic cable (e.g., DAS cable 304). Indeed, identification of the exact location of a fiber optic cable can assist in event detection, characterization and fingerprinting. In the case of a damaged fiber, the implementations can pinpoint the location of the damage (e.g., a flap, or a severance) to assist network operators.

As discussed in association with FIGS. 2A-2C, a DAS fiber network can be buried underground (e.g., 18 to 36 inches underneath the ground level). Through a DAS interrogator unit, vibrational energy that disturbs the optical index of sections of the fiber can induce altered Rayleigh scattering, thus giving rise to a form of acousto-optic modulation. Indeed, DAS interrogator 305 of FIG. 3 can be synchronized with the emission of vibrational energy from mobile platform 301 so that waves caused by the vibrational energy coupled into the subsurface can be detected. Using the detected signal, an imagery of the sub-surface can be reconstructed, for example, to survey the underground where infrastructure 303 can be buried (and remain hard to inspect). Implementations can provide geologic carbon sequestration monitoring, subsurface intelligence data acquisition, geothermal energy production monitoring, and smart city (built environment) monitoring.

In diagram 300, when the fiber-optic cable location is mapped in real time, graph algorithms can be used to optimize the routing of the vehicles for highest efficiency of data gathering in conjunction with the vehicles' other roles. The DAS system (or other sensor system) can have real-time data gathering and processing capabilities. As such, these moveable sources can be strategically moved, in a coordinated fashion, in areas where interesting events have occurred to investigate. In one example, when the moving source is being driven by an operator, the real-time seismic image of the area near the source can be streamed to the operator, much like lidar, except the seismic image pertains to the subsurface. As illustrated, control unit 306 can coordinate the activation of active sources on mobile platform 301 and the operation of DAS interrogator unit 305 so that the vibrational energy is emitted in tandem with probing optical pulses on fiber 304. Control unit 306 can be integrated on mobile platform 301 and can communicate with DAS interrogator unit 305 wirelessly. Control unit 306 can also be a standalone unit that communicates wirelessly with both mobile platform 301 and DAS interrogator unit 305.

FIGS. 4A-4C show examples of test data obtained in accordance with some implementations of the present disclosure. FIG. 4A shows recorded data from a DAS interrogator unit along the length of a fiber-optic cable (vertical axis) over time (horizontal axis). The arrow in FIG. 4A shows the location of a horizontal cut that leads to a temporal waveform, as shown in the top panel of FIG. 4B. The bottom panel of FIG. 4B shows the corresponding spectrogram of the temporal waveform. The oblique streaks 401 and 402 highlight the frequencies played by the speakers of a vehicle. Referring to FIG. 4C, annotations are added to show events of a first moving vehicle at about 40 mph (411), sound signals from speaker (412), and a second moving vehicle (413).

FIG. 5 is a flow chart that shows an example method 500 according to example implementations of the present disclosure. Method 500 can be implemented by or with, for example, one or more of the mobile platforms shown in FIGS. 1A-1C, in conjunction with a control system that is part of or communicably coupled to such platforms.

Method 500 can begin at step 500, which includes generating acoustic wave energy towards a fiber optic network that includes at least one fiber optic cable and at least one distributed acoustic sensing (DAS) interrogator from an active acoustic energy source on a mobile vehicle. For example, the acoustic wave energy can be generated by the active acoustic energy source during movement of the mobile vehicle on the terranean surface (e.g., as a car, truck, or otherwise) or above the terranean surface (e.g., as an unmanned drone, helicopter, ultra-light, hot air balloon, or otherwise). In some aspects, such as when the fiber optic cable is located in a subsurface volume, the acoustic wave energy is operable to penetrate through the terranean surface into the subsurface volume. In some aspects, the fiber optic network is mounted on above-ground infrastructure (e.g., one or utility poles), and the acoustic wave energy can be directed toward the fiber optic network above ground.

In some aspects, the active acoustic energy source is at least one speaker carried on or towed by the mobile vehicle. The speaker(s) can be tilted to at least partially face the subsurface volume (in the case of a buried fiber optic network) or face the infrastructure (in the case of above-ground fiber optic networks) and operated to generate the acoustic wave energy. The acoustic wave energy generated by the speaker(s) can be between 10 Hz and 20 Hz. In some aspects, the speaker(s) include a parabolic surface that can direct the acoustic wave energy into the subsurface volume. In some aspects, the generated acoustic wave energy can be between 100 W and 10000 W.

In some aspects, the active acoustic source is a non-transducer source mounted on or towed by the mobile vehicle. In some aspects, the non-transducer source can be operated during vehicle movement to strike the terranean surface to generate the acoustic wave energy. For instance, the generated acoustic wave energy can be between 10 Hz and 20 Hz from the non-transducer source. As examples, the non-transducer source can be or include a snow tire, a non-uniform tire, an etched tire, an eccentric wheel, a studded tire, a square tires, a flat tire, a forklift tire, or an offset tire. In some aspects, the non-transducer source can be the tire device 112) on hinge 114 of FIG. 1B.

In some aspects, the mobile vehicle is an autonomous mobile vehicle, such as an autonomous roadway vehicle (e.g., a self-driving car that can operate in various levels of autonomy). In some aspects, the autonomous mobile vehicle can be an unmanned drone.

Method 500 can continue at step 504, which includes acquiring a signal from the DAS interrogator in response to the acoustic wave energy generated from the active acoustic energy source (during mobile vehicle movement on or above the terranean surface). For example, as described herein, the acoustic wave energy can impinge on the fiber optical cable (buried or above ground), and induce a form of acousto-optic modulation through Rayleigh scattering. The fiber optic network can include a DAS interrogator unit programmable to send optical pulses down the fiber network in a manner synchronized with the emission of the acoustic wave energy. Strain rate signals can be detected (e.g., through the DAS interrogator unit) that represent the vibrational energy propagating in the fiber optic cable(s). As described above in association with FIGS. 2A-2C, and 3, the DAS interrogator unit can detect altered patterns of Rayleigh scattering in the presence of acoustic or seismic waves created by the vibrational energy.

Method 500 can continue at step 506, which includes determining a geolocation of the mobile vehicle during or subsequent to the acquisition of the signal from the DAS interrogator with a geolocator on the mobile vehicle. For example, a geolocator (such as a GPS device or unit, as well as a time track) can be part of or attached to the mobile vehicle, thereby providing a fairly precise (e.g., 0-3 meters) global location of the mobile vehicle during movement or at a standstill (in three dimensional space if a drone). The geolocator on the mobile vehicle can be queried or otherwise provide a geolocation of the mobile vehicle when (or just after) the signal is acquired from the DAS interrogator response to the acoustic wave energy.

Method 500 can continue at step 508, which includes determining a location (subsurface or above ground) of at least one fiber optic cable of the fiber optic network based on the determined geolocation of the mobile vehicle during acquisition of the signal from the DAS interrogator. For example, the signal acquired from the DAS interrogator can be associated or otherwise mapped to the determined geolocation, thereby providing a fairly precise (e.g., 0-3 meters, 0-5 meters, or otherwise) location of at least one fiber optic cable in the fiber optic network in the subsurface volume or above ground. Information associated with the location of the fiber optic cable can be particularly advantageous. For example, precise knowledge of the location of fiber optic cables in a subsurface fiber optic network may not be known, even in view of construction plans or blueprints of the network. Method 500 can be implemented to obtain such precise information, thereby providing “as-builts” of the network, as well as preventing undesirable damage to the network (e.g., through digging) that occurs due to lack of this location information.

Steps 502 through 508 can be repeated in a serial or parallel fashion. For example, a single mobile vehicle can be operated to repeat steps 502-508 in a serial fashion to more fully map out the locations of fiber optic cables in a subsurface network. As a potentially more efficient process, multiple mobile vehicles can be operated to perform steps 502-508 in parallel to provide for location information on fiber optic cables in a fiber optic network (subsurface or above ground). In some aspects, for instance, a platoon of mobile vehicles (e.g., multiple vehicles operating with a common purpose or by a common or coordinated entity) can be operated (e.g., continuously or semi-continuously) to perform steps 502-508, even if such a process is not the primary purpose of the vehicles. As an example, a ride-share fleet of vehicles can be implemented with active acoustic energy sources and a geolocator, which can be operated according to method 500 during normal ride-sharing trips in an urban, suburban, or rural area.

Steps 502-508 can also be implemented to direct acoustic wave energy both toward a subsurface and above ground (e.g., at the same time) with the mobile vehicle (or multiple mobile vehicles, or a fleet or platoon of mobile vehicles as described) in the case of fiber optic networks located in a subsurface volume and above ground. In some cases, a single fiber optic network can include a portion in the subsurface volume and a portion above ground as well; thus, the directed acoustic wave energy can be applied toward the subsurface volume and above ground at the same time, or alternating if the locations of such portions (below ground and above ground) are generally known.

In the case of above-ground fiber optic networks, the mobile vehicle (or vehicles as the case may be) can also be equipped with video or still image capture equipment. Such image capture equipment can be operated during movement of the mobile vehicle to capture still and/or video images adjacent the mobile vehicle (e.g., front). With such captured image data, a control system or controller at the mobile vehicle (or communicably coupled to the mobile vehicle, e.g., through cloud computing services) can utilize machine learning algorithms to identify or recognize above ground locations that include fiber optic cables mounted on infrastructure. Through this identification, acoustic wave energy sources, such as speakers or otherwise, can be moved, tilted, or positioned to direct acoustic wave energy at the fiber optic cables.

Method 500 can also be implemented to provide additional (or alternative) information on the fiber optic network. For example, method 500 can include step 510, which includes determining additional information on the fiber optic network based on the acquired signal and the determined geolocation of the mobile vehicle during acquisition of the signal from the DAS interrogator. For example, step 510 can include determining a characteristic of the acquired signal from the DAS interrogator in response to the acoustic wave energy generated from the active acoustic energy source during movement of the mobile vehicle. The characteristic (e.g., amplitude, frequency, strain or otherwise) can be used to determine if there is a defect in a fiber optic cable in the network. In combination with the geolocation data of the vehicle, a location of the defect can also be determined.

As another example of step 510, an image of the subsurface volume can be generated at least partially based on the acquired signal from the DAS interrogator (e.g., in the case of subsurface fiber optic networks). This image can include, for example, data related to geologic formations, infrastructure objects, or a combination thereof. In some aspects, as steps 502-506 are repeated in a serial fashion, multiple signals from the DAS interrogator can be acquired in response to the acoustic wave energy generated from the active acoustic energy source during movement of the mobile vehicle. With each acquired signal, a specific geolocation of the mobile vehicle can be determined and associated with a particular one of the signals. In such manner, a dynamic image (e.g., updating in real time to show different images of the subsurface) can be obtained. This dynamic image can be provided, e.g., to an operator or driver of the mobile vehicle for real time feedback of the subsurface.

FIG. 6 is a block diagram illustrating an example of a computer (or control) system 600 used to provide computational functionalities associated with described algorithms, methods, functions, processes, flows, and procedures according to some implementations of the present disclosure. For example, control unit 306 from FIG. 3 (or a control system or controller as part of or communicably coupled to one, some, or all of the mobile platforms shown in FIGS. 1A-1C) can incorporate computer system 600. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format.

While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data 616 for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602. Data 606 can include, for example, data received from DAS interrogator 232, control data being provided to DAS interrogator 232 and active acoustic sources on one or more mobile vehicles.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

FIG. 7 shows a schematic diagram of an example implementation of a seismic imaging system 700 according to the present disclosure. Generally, the seismic imaging system 700 (as shown in exemplary form in FIG. 7) is operable to passively generate seismic (or acoustic) signals 715 toward one or more objects 740 (e.g., human made such as infrastructure or geological structures, formation, objects or anomalies) within a subterranean formation 703 through a regular pattern of travelling vehicles 705 along a surface 701. In example implementations, the surface 701 can be a roadway surface, such as a street (e.g., paved or otherwise), highway, bridge, or otherwise. Installed on (or co-planar with or embedded within) the surface 701 is one or more acoustic generator assemblies 708 operable to, when activated, generate seismic signals 715 toward the object(s) 740 and into the subterranean formation 703.

In an example implementation, the acoustic (or seismic) generator assembly 708 includes a contact plate 712 coupled to a seismic generator 710. The contact plate 712, in this example, is positioned co-planar (or substantially co-planar) with the surface 701. As one or more travelling vehicles 705 run over the contact plate 712 during normal travelling (as shown by the directional arrow). Upon contact with the contact plate 712 (e.g., from a tire or multiple tires of the travelling vehicles 705), the seismic generator 710 is activated to generate the seismic signals 715. Reflected signals 755 from the one or more objects 740 are directed back toward the surface 701 and received by one or more seismic receivers 722 (shown as embedded into the surface 701 but positionable other places, including above the surface 701, as appropriate). The reflected seismic signals 755 can be used, as described generally herein, to generate imagery and other data of the subterranean formation 703 including the object(s) 740 by a control system. This process can be repeated for each travelling vehicle 705 that drives over the contact plate 712.

As further shown in FIG. 7, the acoustic (or seismic) generator assembly 708 (as well as, in some aspects, the seismic receivers 722) can include a geolocation sensor 714 so that, as seismic signals 715 are generated and reflected signals 755 received, imagery or other data generated by the signals 755 can be geolocated. In example aspects, there can be many (e.g., tens, hundreds, thousands) of acoustic generator assemblies 708 positioned along a surface 701, such as a roadway, which is many (e.g., tens, hundreds, thousands) miles long. The multiple (both in location and in time) reflected signals 755 can therefore be geolocated to generate sub-surface imagery that is reflective of both distance or area as well as time. Further, each acoustic generator assembly 708 can be moved or periodically repositioned along the surface 701 to better image other or additional areas over time.

In example aspects, a power source 730 (e.g., renewable such as solar or otherwise) can be electrically coupled to one or more acoustic generator assemblies 708 in the seismic imaging system 700. For example, in the absence of travelling vehicles 705 (or simply between travelling vehicles 705), the power source 730 can supply power to independently activate the seismic generator 710 even in the absence of travelling vehicles 705. In even additional aspects, the contact plate 712 can generate electrical power through the repeated contact of the travelling vehicles 705; such generated power can also be used to independently activate the seismic generator 710 even in the absence of travelling vehicles 705.

In an example implementation according to FIG. 7, a seismic imaging system includes one or more seismic generator assemblies. Each seismic generator assembly includes least one contact plate positionable on or co-planar with a roadway surface on which one or more travelling vehicles move; and a seismic generator coupled with the at least one contact plate and configured to activate to generate one or more seismic signals into a subterranean formation under the roadway surface upon contact of the at least one contact plate by at least one of the one or more travelling vehicles. The system further includes at least one seismic receiver positionable to receive seismic signals reflected from one or more objects in the subterranean formation in response to the generated one or more seismic signals from the seismic generator; and a control system configured to generate one or more subsurface images based on the seismic signals reflected from the one or more objects in the subterranean formation.

In an aspect combinable with the example implementation of the seismic imaging system, each seismic generator assembly includes a geolocation sensor.

In another aspect combinable with one, some, or all of the previous aspects of the seismic imaging system, the one or more seismic generator assemblies includes a plurality of seismic generator assemblies spaced along a particular distance of the roadway surface

In another aspect combinable with one, some, or all of the previous aspects of the seismic imaging system, the particular distance is at least 10 miles.

Another aspect combinable with one, some, or all of the previous aspects of the seismic imaging system further includes a power source configured to activate the seismic generator in the absence of the one or more travelling vehicles to generate the one or more seismic signals.

In another aspect combinable with one, some, or all of the previous aspects of the seismic imaging system, the one or more travelling vehicles is at least 100 travelling vehicles over a particular time duration.

In another aspect combinable with one, some, or all of the previous aspects of the seismic imaging system, contact is between the at least one contact plate and at least one tire of the one or more travelling vehicles.

In another example implementation of FIG. 7, a method for imaging a subsurface includes receiving one or more travelling vehicles at a seismic generator assembly installed on or in a roadway surface; based on contact with a contact plate of the seismic generator assembly by at least one of the one or more travelling vehicles, activating a seismic generator coupled with the contact plate and configured to activate to generate one or more seismic signals into a subterranean formation under the roadway surface; receiving, with at least one seismic receiver, seismic signals reflected from one or more objects in the subterranean formation in response to the generated one or more seismic signals from the seismic generator; and generating, with a control system, one or more subsurface images based on the seismic signals reflected from the one or more objects in the subterranean formation.

An aspect combinable with the example implementation of the method for imaging a subsurface includes geolocating at least some of the seismic signals generated by the seismic generator or the seismic signals reflected from one or more objects in the subterranean formation.

Another aspect combinable with one, some, or all of the previous aspects of the method for imaging a subsurface includes repeating the steps of activating and receiving with a plurality of seismic generator assemblies spaced along a particular distance of the roadway surface.

In another aspect combinable with one, some, or all of the previous aspects of the method for imaging a subsurface, the particular distance is at least 10 miles.

Another aspect combinable with one, some, or all of the previous aspects of the method for imaging a subsurface includes activating, with a renewable power source, the seismic generator in the absence of the one or more travelling vehicles to generate the one or more seismic signals.

In another aspect combinable with one, some, or all of the previous aspects of the method for imaging a subsurface, the one or more travelling vehicles is at least 100 travelling vehicles over a particular time duration.

In another aspect combinable with one, some, or all of the previous aspects of the method for imaging a subsurface, contact is between the at least one contact plate and at least one tire of the one or more travelling vehicles.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures can be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A system, comprising:
a mobile vehicle comprising a geolocator and at least one active acoustic source configured to generate acoustic wave energy directed toward a fiber optic network comprising one or more fiber optic cables and at least one distributed acoustic sensing (DAS) interrogator communicably coupled to at least one of the one or more fiber optic cables; and
a control system configured to perform operations comprising:
acquiring a signal from the at least one DAS interrogator in response to the acoustic wave energy generated from the at least one active acoustic energy source during movement of the mobile vehicle on or above the terranean surface;
determining a geolocation of the mobile vehicle from the geolocator during or subsequent to acquisition of the signal from the at least one DAS interrogator; and
determining a location of the at least one fiber optic cable based on the determined geolocation of the mobile vehicle during acquisition of the signal from the at least one DAS interrogator.

2. The system of claim 1, wherein the operations comprise:
determining a characteristic of the acquired signal from the at least one DAS interrogator in response to the acoustic wave energy generated from the at least one active acoustic energy source during movement of the mobile vehicle on or above the terranean surface; and
based on the characteristic, determining a defect in the at least one fiber optic cable.

3. The system of claim 2, wherein the operations comprise determining a location of the defect in the at least one fiber optic cable based on the determined geolocation of the mobile vehicle during acquisition of the signal from the at least one DAS interrogator.

4. The system of claim 2, wherein the characteristic comprises an amplitude or a frequency of the acquired signal from the at least one DAS interrogator.

5. The system of claim 1, wherein the acoustic wave energy is operable to penetrate through a terranean surface into a subsurface volume that encloses the fiber optic network.

6. The system of claim 5, wherein the operations comprise generating, at least partially based on the acquired signal from the at least one DAS interrogator, an image of the subsurface volume.

7. The system of claim 4, wherein the operation of acquiring the signal from the at least one DAS interrogator in response to the acoustic wave energy generated from the at least one active acoustic energy source during movement of the mobile vehicle on or above the terranean surface comprises:
acquiring a plurality of signals from the at least one DAS interrogator in response to the acoustic wave energy generated from the at least one active acoustic energy source during movement of the mobile vehicle on or above the terranean surface.

8. The system of claim 7, wherein the operations comprise:
determining a plurality of geolocations of the mobile vehicle from the geolocator during or subsequent to acquisition of the plurality of signals from the at least one DAS interrogator; and
associating each geolocation of the plurality of geolocations with a particular signal of the plurality of signals acquired from the at least one DAS interrogator.

9. The system of claim 8, wherein the acoustic wave energy is operable to penetrate through a terranean surface into a subsurface volume that encloses the fiber optic network, and the operations comprise generating, at least partially based on the acquired plurality of signals from the at least one DAS interrogator, a dynamic image of the subsurface volume during movement of the mobile vehicle.

10. The system of claim 9, wherein the operations comprise projecting the dynamic image of the subsurface volume at the mobile vehicle during movement of the mobile vehicle.

11. The system of claim 1, wherein the at least one active acoustic source comprises a speaker tilted toward a location of the fiber optic network and configured to generate the acoustic wave energy.

12. The system of claim 11, wherein the acoustic wave energy is generated between 10 Hz and 20 Hz.

13. The system of claim 11, wherein the speaker comprises a parabolic surface configured to direct the acoustic wave energy into the subsurface volume.

14. The system of claim 1, wherein the acoustic wave energy is between 100 W and 10000 W.

15. The system of claim 10, wherein the at least one active acoustic source comprises a non-transducer source mounted on the mobile vehicle.

16. The system of claim 15, wherein the non-transducer source is configured to strike the terranean surface to generate the acoustic wave energy during movement of the mobile vehicle.

17. The system of claim 16, wherein the generated acoustic wave energy is between 10 Hz and 20 Hz.

18. The system of claim 15, wherein the non-transducer source comprises at least one of: a snow tire, a non-uniform tire, an etched tire, an eccentric wheel, a studded tire, a square tires, a flat tire, a forklift tire, or an offset tire.

19. The system of claim 16, wherein the non-transducer source is towed by the mobile vehicle.

20. The system of claim 1, wherein the mobile vehicle comprises an autonomous mobile vehicle.

21. The system of claim 1, wherein the autonomous mobile vehicle comprises an autonomous roadway vehicle.

22. The system of claim 1, wherein the mobile vehicle is a first mobile vehicle, the system comprising a second mobile vehicle comprising a second geolocator and at least one second active acoustic source configured to generate acoustic wave energy directed toward the fiber optic network, and the operations comprise:
acquiring a second signal from the at least one DAS interrogator in response to the acoustic wave energy generated from the at least one second active acoustic energy source during movement of the second mobile vehicle on or above the terranean surface;
determining a geolocation of the second mobile vehicle from the second geolocator during or subsequent to acquisition of the second signal from the at least one DAS interrogator; and
determining a second location of the at least one fiber optic cable based on the determined second geolocation of the second mobile vehicle during acquisition of the second signal from the at least one DAS interrogator.

23. The system of claim 22, wherein the first and second mobile vehicles are or are part of a platoon of mobile vehicles.

24. The system of claim 23, wherein the platoon of mobile vehicles comprises a platoon of autonomous mobile vehicles.

25. The system of claim 1, wherein the fiber optic network is mounted on infrastructure above the terranean surface, and the at least one active acoustic source is configured to the generate acoustic wave energy directed toward the fiber optic network.

26. The system of claim 25, wherein the infrastructure comprises one or more utility poles.

27. A method, comprising:
generating, from at least one active acoustic source on a mobile vehicle during movement of the mobile vehicle on or above a terranean surface, acoustic wave energy directed toward a fiber optic network comprising one or more fiber optic cables and at least one distributed acoustic sensing (DAS) interrogator communicably coupled to at least one of the one or more fiber optic cables;
acquiring a signal from the at least one DAS interrogator in response to the acoustic wave energy generated from the at least one active acoustic energy source;
determining, with a geolocator on the mobile vehicle, a geolocation of the mobile vehicle during or subsequent to acquisition of the signal from the at least one DAS interrogator; and
determining a location of the at least one fiber optic cable based on the determined geolocation of the mobile vehicle during acquisition of the signal from the at least one DAS interrogator.

28. The method of claim 27, further comprising:
determining a characteristic of the acquired signal from the at least one DAS interrogator in response to the acoustic wave energy generated from the at least one active acoustic energy source during movement of the mobile vehicle on or above the terranean surface; and
based on the characteristic, determining a defect in the at least one fiber optic cable.

29. The method of claim 28, further comprising determining a location of the defect in the at least one fiber optic cable based on the determined geolocation of the mobile vehicle during acquisition of the signal from the at least one DAS interrogator.

30. The method of claim 28, wherein the characteristic comprises an amplitude or a frequency of the acquired signal from the at least one DAS interrogator.

31. The method of claim 30, wherein the acoustic wave energy is operable to penetrate through a terranean surface into a subsurface volume that encloses the fiber optic network.

32. The method of claim 31, further comprising generating, at least partially based on the acquired signal from the at least one DAS interrogator, an image of the subsurface volume.

33. The method of claim 30, wherein acquiring the signal from the at least one DAS interrogator in response to the acoustic wave energy generated from the at least one active acoustic energy source comprises:
acquiring a plurality of signals from the at least one DAS interrogator in response to the acoustic wave energy generated from the at least one active acoustic energy source during movement of the mobile vehicle on or above the terranean surface.

34. The method of claim 33, further comprising:
determining a plurality of geolocations of the mobile vehicle from the geolocator during or subsequent to acquisition of the plurality of signals from the at least one DAS interrogator; and
associating each geolocation of the plurality of geolocations with a particular signal of the plurality of signals acquired from the at least one DAS interrogator.

35. The method of claim 34, wherein the acoustic wave energy is operable to penetrate through a terranean surface into a subsurface volume that encloses the fiber optic network, and the method further comprises generating, at least partially based on the acquired plurality of signals from the at least one DAS interrogator, a dynamic image of the subsurface volume during movement of the mobile vehicle.

36. The method of claim 35, further comprising projecting the dynamic image of the subsurface volume at the mobile vehicle during movement of the mobile vehicle.

37. The method of claim 27, wherein the at least one active acoustic source comprises a speaker tilted to at least partially face the subsurface volume, the method comprising:
generating the acoustic wave energy from the speaker during movement of the mobile vehicle on or above the terranean surface.

38. The method of claim 37, wherein the acoustic wave energy is generated between 10 Hz and 20 Hz.

39. The method of claim 37, further comprising directing the acoustic wave energy into a subsurface volume from a parabolic surface of the speaker.

40. The method of claim 27, wherein the acoustic wave energy is between 100 W and 10000 W.

41. The method of claim 36, wherein the at least one active acoustic source comprises a non-transducer source mounted on the mobile vehicle, the method comprising:
generating the acoustic wave energy from the non-transducer source during movement of the mobile vehicle on or above the terranean surface.

42. The method of claim 41, wherein generating the acoustic wave energy from the non-transducer source during movement of the mobile vehicle on or above the terranean surface comprises:
operating the non-transducer source to strike the terranean surface to generate the acoustic wave energy during movement of the mobile vehicle.

43. The method of claim 42, wherein the generated acoustic wave energy is between 10 Hz and 20 Hz.

44. The method of claim 41, wherein the non-transducer source comprises at least one of: a snow tire, a non-uniform tire, an etched tire, an eccentric wheel, a studded tire, a square tires, a flat tire, a forklift tire, or an offset tire.

45. The method of claim 43, wherein the non-transducer source is towed by the mobile vehicle.

46. The method of claim 27, wherein the mobile vehicle comprises an autonomous mobile vehicle.

47. The method of claim 46, wherein the autonomous mobile vehicle comprises an autonomous roadway vehicle.

48. The method of claim 27, wherein the mobile vehicle is a first mobile vehicle, the method comprising:
generating, from at least one second active acoustic source on a second mobile vehicle during movement of the second mobile vehicle on or above the terranean surface, second acoustic wave energy directed toward the fiber optic network comprising one or more fiber optic cables and at least one DAS interrogator communicably coupled to at least one of the one or more fiber optic cables;
acquiring a second signal from the at least one DAS interrogator in response to the second acoustic wave energy generated from the at least one second active acoustic energy source;
determining, with a geolocator on the second mobile vehicle, a geolocation of the second mobile vehicle during or subsequent to acquisition of the second signal from the at least one DAS interrogator; and
determining a second location of the at least one fiber optic cable based on the determined geolocation of the second mobile vehicle during acquisition of the second signal from the at least one DAS interrogator.

49. The method of claim 48, wherein the first and second mobile vehicles are or are part of a platoon of mobile vehicles.

50. The method of claim 49, wherein the platoon of mobile vehicles comprises a platoon of autonomous mobile vehicles.

51. The method of claim 27, wherein the fiber optic network is mounted on infrastructure above the terranean surface, the method comprising directing the generate acoustic wave energy towards the fiber optic network mounted on the infrastructure.

52. The method of claim 51, wherein the infrastructure comprises one or more utility poles.
